(19) United States
(12) Patent Application Publication
(10) Pub. No.: US 2009/0230742 A1
(43) Pub. Date: Sep. 17, 2009

(54) Pneumatic Vehicle Seat

(76) Inventors: Daniel Habegger, Zurich (CH); Laszlo Kerekes, Zurich (CH)

Correspondence Address: WINSTEAD PC, P.O. BOX 50784, DALLAS, TX, 75201, US

(21) Appl. No.: 11/922,858

(22) PCT Filed: Nov. 25, 2005
(86) PCT No.: PCT/CH2005/000699

§ 371 Date: Apr. 8, 2008

(30) Foreign Application Priority Data
Jul. 20, 2005 (CH) 1202/05

(51) Int. Cl. B60N 2/20; B60N 2/30; B60N 2/44; B60N 2/64

(52) U.S. Cl. 297/257; 297/452.41; 297/378.1; 297/284.1

(57) ABSTRACT

The invention relates to a backseat with a base plate (1) and a corresponding back plate (11) on which one layer (2) ON of foam each or pneumatic cushions covering both plates (1, 11) are arranged. Following pneumatic cushions are placed on said layer (2) and are suitably secured thereto: For every passenger occupying a window seat, one edge cushion (13) each, resting towards outside and towards inside, and one lateral cushion (4, 14) each, resting towards inside, is provided, the latter being impinged upon with tensile forces by tension elements (9, 19) inserted in a tube (8) for the rapid evacuation of air. In the center of the backseat, a planar cushion (5, 15) is located and may also serve as a center shelf. The back plate (11) may be subdivided into two back plates (11a, b) which occupy approximately ⅓ and ⅔ of the width thereof. The pneumatic cushions can be impinged upon with pressure and can be evacuated individually by means of a control. Once the air is evacuated from the cushions, the back plate (11a, b) can be folded onto the base plate (1) entirely or partially.

### BACKGROUND OF THE INVENTION

1. Technical Field

The present invention relates to pneumatic seats for vehicles, more preferably back seats for motor vehicles.

2. History of Related Art

Numerous pneumatic and adaptive solutions are known for driver's seats and seats of passengers sitting at the front, such as for example from DE 36 90 372. The back seats of motor vehicles, which are mostly also embodied capable of being folded down, however, have not been dealt with much with regard to pneumatic upholstery. Thus, the known solutions for driver's seats are generally not very suitable for rear seats because of their distinct contouring.

### SUMMARY OF THE INVENTION

The object which is to be solved with rear seats in the creation of pneumatic equipment more preferably consists in embodying both the seat and also the back rest and additional upholstered areas so that after the evacuation of the air cushion forming the upholstery a flat, low and preferably plane structure is created for and after the folding-down of the backrest.

The object additionally consists in embodying the back seats in such a manner that these can adapt to passengers of varying physique. The solution of the set object is reflected in the characterizing part of claim 1 in terms of the essential features and in the following claims in terms of additional advantageous embodiments.

### BRIEF DESCRIPTION OF THE DRAWINGS

A more complete understanding of the lighter-than-air flying vehicle of the present invention may be obtained by reference to the following Detailed Description, when taken in conjunction with the accompanying Drawings, wherein:

FIG. 1 is a vertical section across the vehicle direction through a first exemplary embodiment of a back seat;

FIG. 2 is a horizontal section across the vehicle direction through a first exemplary embodiment of a back rest;

FIG. 3 is a vertical section in vehicle direction through a detail of a back seat;

FIG. 4 is a horizontal section through a second exemplary embodiment of a back rest; and

FIG. 5 is a horizontal section through a third exemplary embodiment of a backrest.

### DETAILED DESCRIPTION OF THE DRAWINGS

Various embodiments of the present invention will now be described more fully with reference to the accompanying drawings. The invention may, however, be embodied in many different forms and should not be constructed as limited to the embodiments set forth herein; rather, the embodiments are provided so that this disclosure will be thorough and complete, and will fully convey the scope of the invention to those skilled in the art.

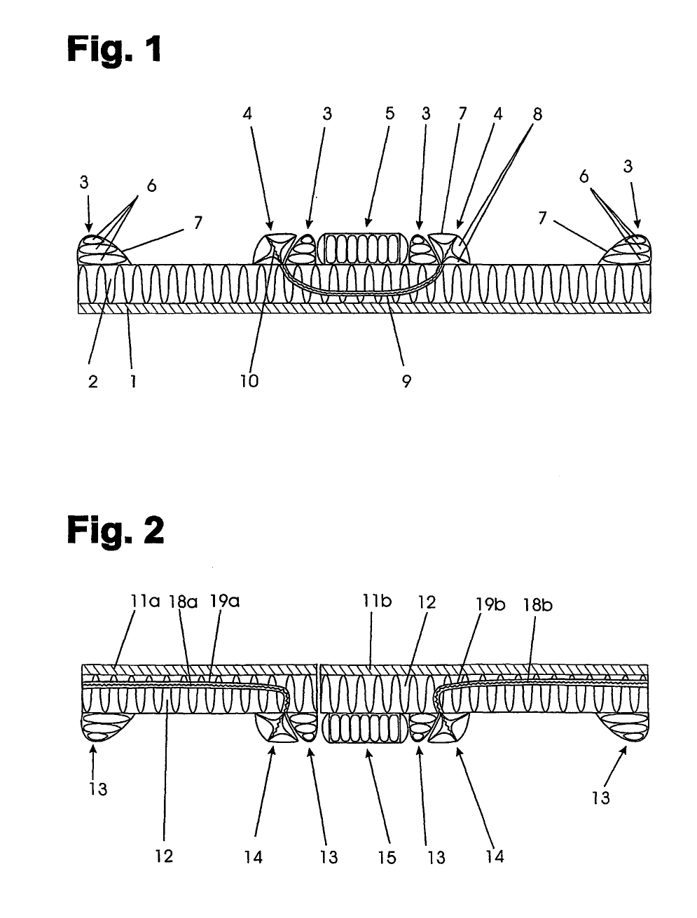

FIG. 1 shows a first exemplary embodiment of a vehicle seat according to the invention. Vehicle back seats are—depending on manufacturer and model—constructed in a great variety. Depending on the manufacturer and model the mechanical construction of a back seat is based on a flat base plate or can also be constructed in a highly contoured manner. With the present invention it is possible—with appropriate adaptation—to take into account such different constructions. FIG. 1 therefore shows the rear seat bench of a vehicle model having a flat base plate 1. In the following, base plate 1 also means such contoured embodiments. In FIG. 1 this base plate 1 is covered with a layer 2 of foam, which as a rule is glued onto the base plate 1. On this layer 2, a plurality, now pneumatic cushions, is arranged and joined with said layer in a suitable manner. Not shown is the textile covering and a possible foam layer inserted between said covering and the layer 2. As pneumatic cushions are provided here: marginal cushions 3, lateral cushions 4 and a seat cushion. The marginal cushions 3 are manufactured for example of a plurality of bladders 6 stacked on top of one another in a textile covering 7; the lateral cushions consist for example of four bladders 8, which are joined with one another at the long sides and are likewise provided with a textile covering. These textile coverings 7 are preferably manufactured of a fabric with low stretch. The seat cushion is a pneumatic cushion 5 known per se with webs, for example a so-called web cushion. The two lateral cushions 4 shown here are joined with each other by way of a tube 9 in which a spring element 10 is inserted. This spring element 10, for example an elastic, brings about rapid evacuation of the lateral cushions 4. Instead of the layer 2 of foam, a flat, for example a so-called web cushion, can also be inserted throughout the entire seat width. The seat cushion is then placed on said web cushion and fastened to it. When the pneumatic cushions 3,4,5 are evacuated, the layer 2 in the exemplary embodiment shown is flat.

FIG. 2 shows the backrest in the cross section analogue to FIG. 1. The backrest consists of a first back plate 11a, which takes up approximately ⅓ of the width and a second back plate 11b. The two back plates 11a, b together form the back plate 11. Fitting the backrest with foam in a layer 12, pneumatic marginal cushions 13, lateral cushions 14 and the rest cushions 15 substantially corresponds to that of the seat. Owing to the ⅓-3 ⅔ division of the back plate 11 the tube corresponding to the tube 9 of the seat is divided into two tubes 19a, 19b, likewise the inserted spring elements 18a, 18b, which divert their tensile force in a suitable manner to the back plates 11a, b. Again, the layer 12 of foam can be replaced through a web cushion of the known type.

If the pneumatic cushions 3, 4, 5, 13, 14, 15 are completely or partially evacuated, the backrest as a whole can be folded forward. If the back plate 11a—corresponding to ⅓ of the entire seat width, is to be folded forward, it is sufficient to evacuate the pneumatic cushions 3, 4 and the pneumatic cushions 3,4 of the backrest on the same side. To this end, valves which are not shown are available and can, if applicable, be operated as a whole through a suitable control.

If the back seat described is to be utilized only by two persons, or is not to comprise a centre tray formed through the seat cushion 5, the marginal cushions 3 located in the centre, the lateral cushions 4 and the seat cushion 5 can be evacuated.

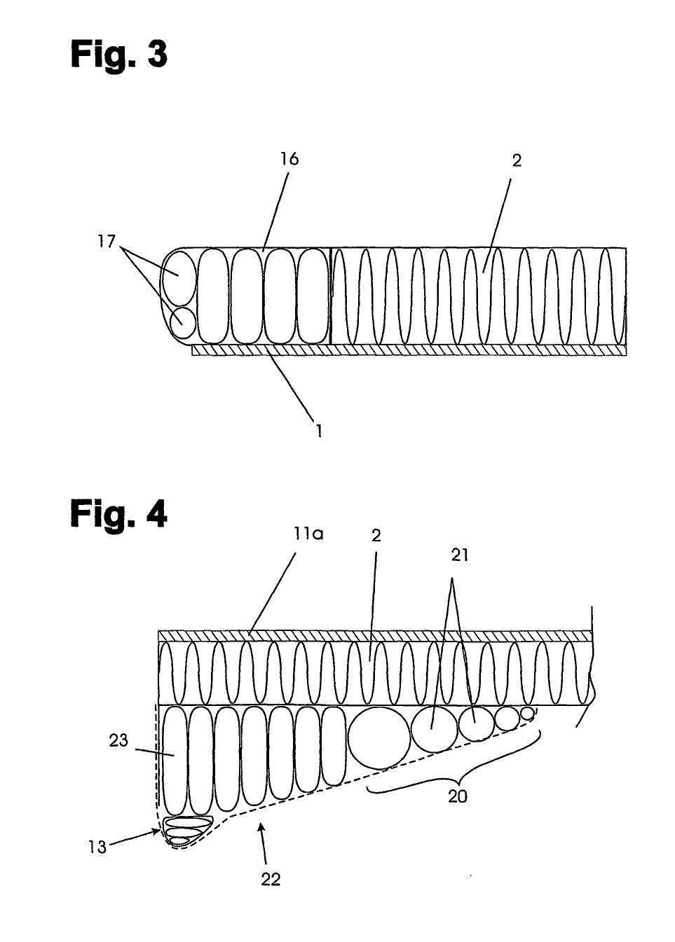

Both the base plate 1 as well as the backrest 11 can be constructed of foam or pneumatic cushions of metal, plastic, textile material, lattices, braidings or combinations thereof for the support and fastening of layer 2. Likewise the base plate 1 and the backrest for the holder, the ergonomics and/or the fastening of the pneumatic cushions, the foam and the textile coverings can be shaped in a suitable manner. FIG. 3 shows a version of this as longitudinal section in direction of driving through the seat bench. The base plate 1 carries the layer 2, which, here, does not cover the entire depth of the seat bench. In the knee region of the passenger the layer 2 is replaced with a web cushion 16, which at the front edge additionally carries two fitted and suitably attached air cores 17. These air cores 17 can also be designed differently to what is shown. Design requirements can thus be largely satisfied. When the back plate 11 is folded down the belt reels, which for example are fastened to the back plate 11, often protrude to such an extent that the back plate 11 will not lie substantially flat. If however in the region of these belt reels the layer 2 is replaced with the pneumatic cushions 16, 17, the mentioned belt reels can be folded into a depression which will be created upon evacuation of these mentioned cushions 16, 17.

FIG. 4 shows the part of the back seat in the region of the first back plate 11a which can be folded down separately. Again, the back plate 11a is provided with a basic upholstery through a layer 2 of foam. Placed on this and suitably fastened is for example a pneumatic cushion designed in two pieces comprising a first part 20 of air cores 21 and a second part 22 of a web cushion 23. The marginal cushion 13 is then fastened on the web cushion 23.

The second back plate 11b is not shown here, however, is equipped identically in mirror image. If the back seat is occupied by three persons this equipment shown in FIG. 1, 2, 4 in the state loaded with compressed air results in that the person sitting in the middle would be sitting slightly higher and slightly further forward than the persons sitting on the outside. These, in turn, through the arrangement of the cushion configuration shown in FIG. 4, would be sitting somewhat turned inward. In this way it is prevented that the three persons touch and crowd one another in the shoulder region.

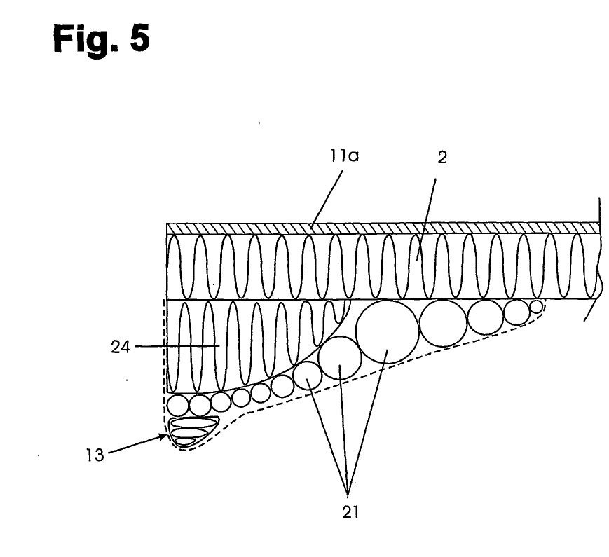

FIG. 5 shows a third exemplary embodiment of the pneumatic equipment of the back seat in the view corresponding to FIG. 4. The construction of back plate 11a and layer 2 is the same as described for FIG. 4. Placed on layer 2 and suitably fastened to said layer is a further, now contoured layer 24 of foam. This is covered with a cushion 25 which preferentially is manufactured of air cores 21. These air cores 21 are—corresponding to those of FIG. 4, manufactured with regard to their sizes in such a manner that in the state supplied with compressed air the contour shown is created. The marginal cushion 13 in this exemplary embodiment is also placed onto the cushion 25 and suitably fastened thereon. Not shown, but easily deducible from what has been shown and said so far, is the following embodiment version. If the dimensions of the vehicle seat are such that the back plates 11a, b each comprise a protrusion for the rear wheelhouses, the layer 24 can be placed on this protrusion. Then, the pneumatic equipment remains as shown in FIG. 5. Obviously it is possible to amend the exemplary embodiment of FIG. 4 and that of FIG. 5 through a lateral cushion 13 according to FIG. 2.

Although various embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

1. A pneumatic back seat for motor vehicles with pneumatic seat cushions comprising:
a seat bench, the seat bench constructed of a base plate covered with a first layer of foam or a pneumatic cushion;
a backrest, the backrest constructed of a back plate covered with a second layer of foam or a pneumatic cushion; and
the seat bench is placed and suitably fastened on the first layer and is adapted to carry the following pneumatic cushions:
a plurality of marginal cushions each arranged on a left and right of passengers sitting on an outside region; and,
a cushion adapted to be used as centre tray;
the backrest is placed onto the second layer and attached to the first layer carrying the pneumatic cushions.

2. The pneumatic back seat according to claim 1, wherein the backrest carries the following pneumatic cushions:
a plurality of marginal cushions, each of the plurality of marginal cushions of the backrest are arranged on a left and right of each of the passengers sitting on the outside region;
a rest cushion; and
wherein following a complete or partial evacuation of the pneumatic cushions. which hinder folding-down of the backrest, both the back seat and the backrest are substantially flat and the backrest is substantially folded down horizontally onto the back seat.

3. The pneumatic back seat according to claim 2, wherein:
the seat bench adjoining the cushion and each of the plurality of marginal cushions of the seat bench carries a plurality of lateral cushions, each of the plurality of lateral cushions are placed on the first layer and suitably fastened thereon; and
the backrest adjoining the rest cushion and the plurality of marginal cushions carry a plurality of lateral cushions, each of the plurality of lateral cushions are placed and suitably fastened on the second layer.

4. The pneumatic back seat according to claim 3, wherein the back plate comprises:
a first back plate comprising ⅓ of the back plate;
a second back plate comprising ⅔ of the back plate;
wherein each of which can be individually folded down following an evacuation of the corresponding pneumatic cushions.

5. The pneumatic back seat according to claim 4, wherein
the plurality of lateral cushions of the seat bench are joined through a spring element, wherein the spring element runs between the plurality of lateral cushions and is inserted in a tube;
each of the plurality of lateral cushions of the backrest are joined by means of spring elements with a part of the back plate; and
wherein the spring elements are inserted in a plurality of tubes.

6. The pneumatic back seat according to claim 3, wherein a pneumatic valve control is present which allows that the pneumatic cushions are each activated individually and can be individually pressurized and evacuated by way of the pneumatic valve control.

7. The pneumatic back seat according to claim 3, wherein the second layer of the backrest carries a first part and a second part wherein the first part comprises vertically oriented air cores and the second part comprises of a web cushion, and wherein the first part and the second part are adapted to bring about a contour which rises in a direction of a front and in a direction of an outside in such a manner that the passenger resting against the first part and the second part is able to sit turned-in towards the inside.

8. The pneumatic back seat according to claim 7, wherein the plurality of marginal cushions are placed on and suitably fastened to the web cushion.

9. The pneumatic back seat according to claim 1, wherein the back plate is embodied in a contoured manner either in a region of a wheelhouses and/or carries a contoured layer of foam or a likewise contoured web cushion, placed on which and suitably fastened to which is a cushion of air cores, wherein the contoured web cushion brings about a contour that rises in a direction of a front and in a direction of an outside in such a manner that the passenger resting against it is able to sit turned-in towards the inside.

10. The pneumatic back seat according to claim 9, wherein the plurality of marginal cushions are placed on and suitably fastened to a web cushion.

11. The pneumatic back seat according to claim 1, wherein the first layer of foam in a knee region of the passenger is replaced with a pneumatic cushion through a web cushion, the pneumatic cushion comprising fitted and suitably fastened air cores oriented horizontally so that belt reels fastened to the back plate after an evacuation of the web cushion and the air cores fit in gaps to allow the back plate to fully fold down.

12. The pneumatic back seat according to claim 1, wherein the base plate and the back rest for supporting and fastening of the first layer comprises metal, plastic, textile material, lattices, braidings or combinations thereof, and that the base plate and the back rest are suitably shaped for holding, ergonomics and/or fastening of the pneumatic cushions, the foam and textile coverings.
